(19) United States
(12) Patent Application Publication
(10) Pub. No.: US 2022/0154588 A1
(43) Pub. Date: May 19, 2022

(54) STEAM TURBINE WITH ROTATABLE STATOR BLADES

(71) Applicant: NUOVO PIGNONE TECNOLOGIE - S.r.l., Florence (IT)

(72) Inventors: Lorenzo Cosi, Florence (IT); Enrico Giusti, Florence (IT); Andrea Paggini, Florence (IT); Damaso Checcacci, Florence (IT); Federico Bucciarelli, Florence (IT); Massimiliano Gagliano, Florence (IT); Marco Fiori, Florence (IT); Damiano Guadagnoli, Florence (IT)

(21) Appl. No.: 17/594,045

(22) PCT Filed: Apr. 3, 2020
(86) PCT No.: PCT/EP2020/025161

§ 371 Date: Sep. 30, 2021

(30) Foreign Application Priority Data
Apr. 5, 2019 (IT) 102019000005266

(51) Int. Cl. F01D 9/04

(52) U.S. Cl. CPC F01D 9/041

(57) ABSTRACT

The steam turbine has a plurality of expansion stages and stator blades upstream at least one of the expansion stages; in order to regulate steam flow inside the steam turbine and maximize turbine efficiency, the angular positions of the stator blades are controlled for example by an external control unit through e.g. a command rod during operation of the steam turbine.

### TECHNICAL FIELD

The subject-matter disclosed herein relates to steam turbines, in particular to mechanical drive turbines and power generation turbines, which requires a control on the steam flow and/or on the power output.

### BACKGROUND

Steam turbines are turbomachines with over one hundred years of industrial applications wherein proven design solutions have been adopted by all manufacturers since decades.

Steam turbine flow and power control is a critical requirement for mechanical drive steam turbines (i.e. steam turbines utilized to drive compressors or pumps).

Also power generation steam turbines are often required to have a control on the load.

Steam turbine flow and power control is typically accomplished by placing throttling valves upstream of the turbine or a “partial arc control stage” inside the turbine itself.

These devices achieve control by limiting the amount and/or the pressure of the steam in the turbine. However, these solutions can determine significant pressure drops that lead to an undesirable dissipation of energy.

Considering the increased demand for efficiency at design and off-design conditions in industrial steam turbines, it would by desirable to find alternative solutions to control the flow and/or the power of a steam turbine which reduce energy dissipation.

Steam turbines are known wherein the angular positions of some stator blades are varied in order to control their operation.

If the above-mentioned solution is used for high-pressure steam turbines considerable leakage of steam occurs as through openings in their casing which are necessary for commanding the stator blades.

### SUMMARY

According to one aspect, the subject-matter disclosed herein relates to a steam turbine with a plurality of expansion stages; the steam turbine has a row of stator blades upstream at least one of the expansion stages; the stator blades of the row have angular positions controlled by an actuation assembly during operation of the steam turbine. The actuation assembly includes a command rod, an actuation mechanism mechanically coupled to the command rod, and a plurality of transmission devices mechanically coupled to the actuation mechanism and to the stator blades. By acting on the command rod which is at least partially external to an outer casing of the steam turbine the stator blades which are internal to an inner casing of the steam turbine may be rotated.

According to another aspect, the subject-matter disclosed herein relates to a method of controlling steam flow and power output of a steam turbine; the method comprises the step of changing angular positions of at least one row of stator blades during operation of the steam turbine through a command rod protruding from an outer casing of the steam turbine. A rotatable ring which is internal to the outer casing of the steam turbine is used for transmitting movement from the command rod to the stator blades.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic longitudinal-section view of a known steam turbine;

FIG. 2 illustrates a partial schematic longitudinal-section view of an embodiment of a steam turbine;

FIG. 3 illustrates a partial schematic front-section view of a first embodiment of an actuation assembly in the turbine of FIG. 2;

FIG. 4 illustrates a partial schematic longitudinal-section view of a first possible implementation of the actuation assembly of FIG. 3;

FIG. 5 illustrates a partial schematic top view of a first possible implementation of the actuation assembly of FIG. 3;

FIG. 6 illustrates a partial schematic longitudinal-section view of a second possible implementation of the actuation assembly of FIG. 3;

FIG. 7 illustrates a partial schematic top view of a second possible implementation of the actuation assembly of FIG. 3;

FIG. 8 illustrates a partial schematic top view of a third possible implementation of the actuation assembly of FIG. 3;

FIG. 9 illustrates a partial schematic longitudinal-section view of a fourth possible implementation of the actuation assembly of FIG. 3;

FIG. 10 illustrates a partial schematic front-section view of a command rod in the turbine of FIG. 2; and

FIG. 11 shows a flow chart of an embodiment of a method of regulating steam flow in a steam turbine.

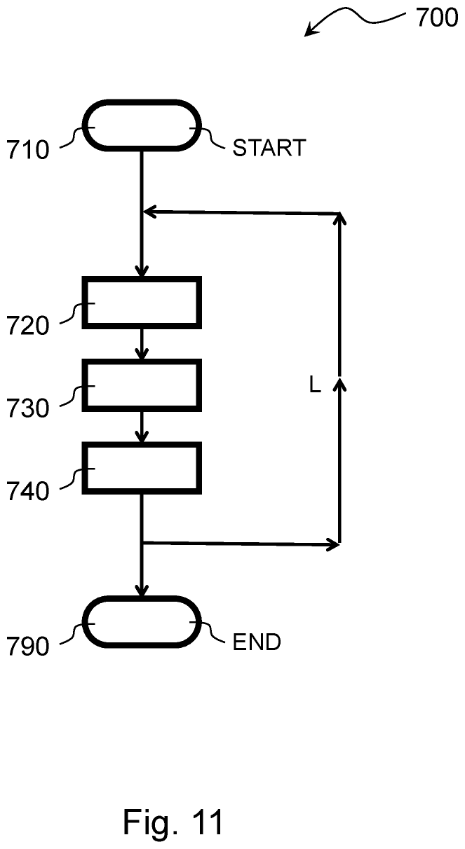

### DETAILED DESCRIPTION OF EMBODIMENTS

Steam turbines used for either mechanical drive or power generation purposes are required to control the mass flow and/or the power output for a given steam pressure ratio and inlet conditions (pressure and temperature).

Control of mass flow and power is typically achieved using a throttling valve or a partial arc control stage solutions which exploit their function varying the pressure ahead of the turbine axial stages and eventually varying the pressure ratio across the turbine stages. These methods, although vastly applied in the Steam Turbines industry, feature a low iso-entropic efficiency outside of their design conditions because throttling (which is applied in both methods) is a pure mechanical energy dissipation and partial arc stage is characterized by high aerodynamics losses due to the intrinsic flow non uniformity and windage.

The applicants have conceived a different solution in which the control of the mass flow is achieved by varying the angular position of at least the first row of stator blades.

Varying the angular position of the stator blades in the row of an axial stage of a steam turbine allows modifying the operating curve (flow rate vs. pressure) of the stage. In particular, the operating curve is changed as a result of the variation of the throat area between the rotatable stator blades.

This solution achieves a much higher efficiency outside of the design operative conditions of the turbine as it avoids the energy dissipation related to the use of either throttling or partial arc. In particular the efficiency of the steam turbine stays close to the design level even outside of the design operative conditions

More in detail, the Applicant has thought of changing the angular positions of stator blades by means of a control unit external to the turbine during operation of the steam turbine.

Advantageously, one or more other rows of stator blades are controlled depending on the flow variation and efficiency level required.

In the light of the specific architecture of steam turbines, in particular, those for mechanical drive or power generation applications, the Applicant has conceived specific and advantageous solutions to actuate the stator blades.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

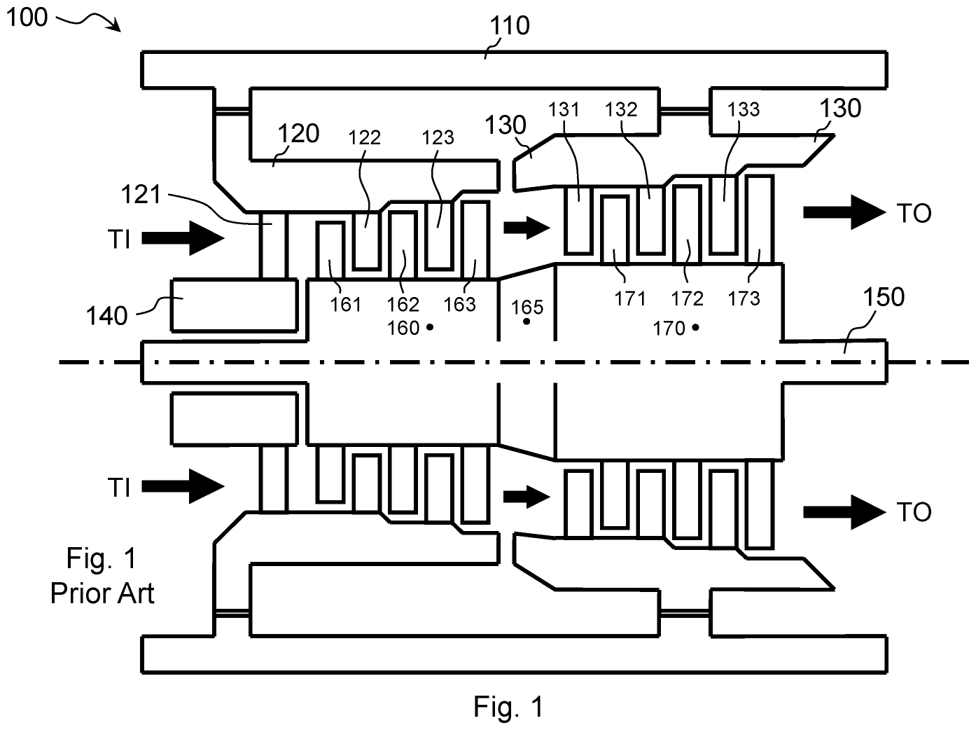

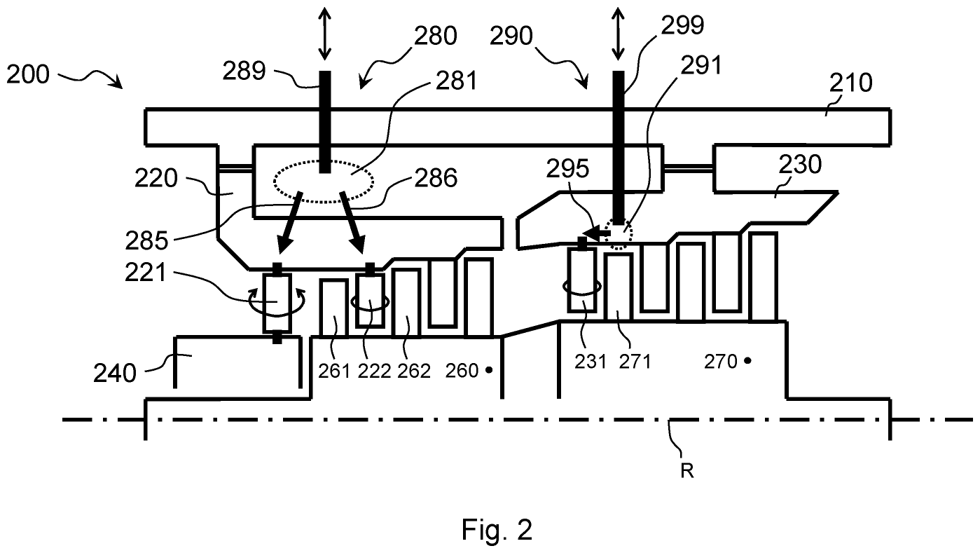

Referring now to the drawings, FIG. 1 is a view of a known steam turbine 100 and FIG. 2 is a (partial) view of an embodiment of a new steam turbine 200 modified from the turbine of FIG. 1; components of steam turbine 200 and corresponding components of turbine 100 are identified by reference numbers differing by one hundred.

Steam turbine 200 of FIG. 2 essentially differs from steam turbine 100 of FIG. 1 in that blades of at least one row of blades, specifically blades of three rows of blades (namely blades 221, 222 and 231), may move during operation of steam turbine; in particular, the angular positions around an axis of these blades may be varied during operation of steam turbine; this axis is radially oriented. In particular, a high-pressure section of steam turbine 200 comprises at least first rotor blades stages section 260, first inner casing section 220, blades 221, blades 261, blades 222, blades 262. A low-pressure section of steam turbine 200 comprises at least second rotor blades stages section 270, second inner casing section 230, blades 231 and blades 271.

Typically, all the blades of a row may move; however, it is not to be excluded that according to some embodiments only some of the blades of a row may move.

It is to be clarified that FIG. 2 and its relation with FIG. 1 should not be construed restrictively. Many other embodiments are possible for example with different numbers of blades rows and/or different number of turbine sections.

In FIG. 2, the possibilities of movement and the devices allowing such possibilities of movement are shown conceptually.

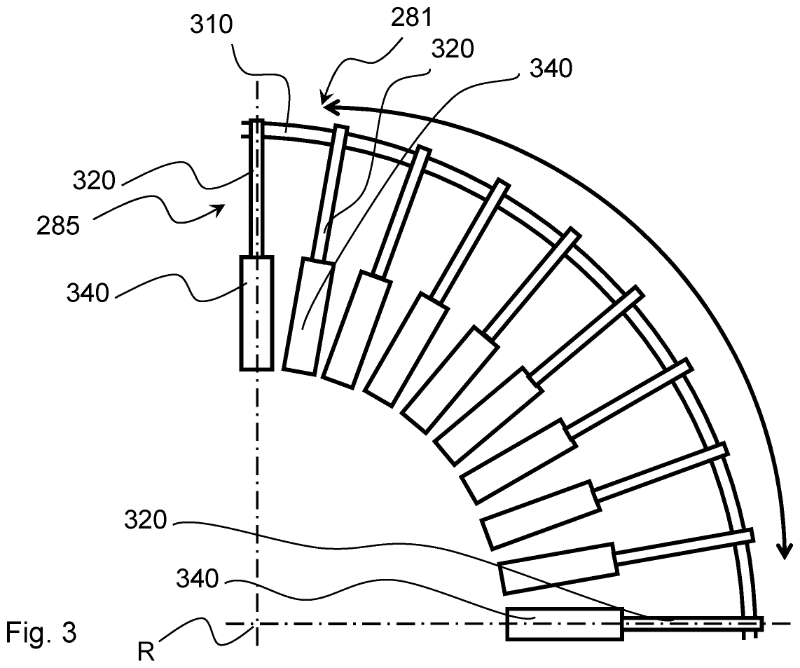

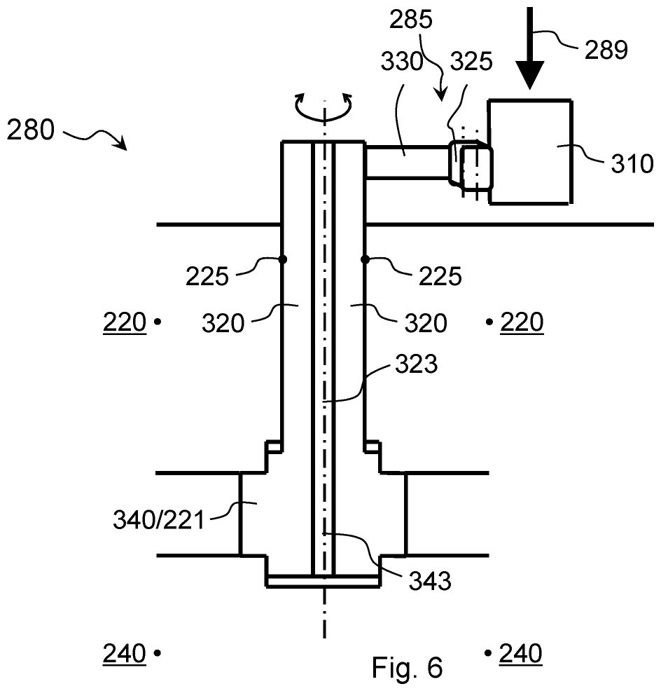

In the embodiment of FIG. 2, there is a first actuation assembly 280 (see also FIG. 3) arranged to rotate the stator blades 221 and 222, and a second actuation assembly 290 (see also FIG. 6) arranged to rotate the stator blades 231. The first actuation assembly comprises an actuation mechanism and two pluralities of transmission devices, and is commanded by a command rod; the actuation mechanism is conceptually shown by a dotted-line circle 281; the first plurality of transmission devices (for blades 221) is conceptually shown by an arrow 285; the second plurality of transmission devices (for blades 222) is conceptually shown by an arrow 286; the command rod operatively coupled with the actuation mechanism is conceptually shown by a stripe 289. The second actuation assembly comprises an actuation mechanism and a plurality of transmission devices and is commanded by a command rod; the actuation mechanism is conceptually shown by a dotted-line circle 291; the transmission devices (for blades 231) are conceptually shown by an arrow 295; the command rod operatively coupled with the actuation mechanism is conceptually shown by a stripe 299.

According to the embodiment of FIG. 2, there is at least one row of stator blades just upstream at least one expansion stage; this applies for example to blades 221 with respect to rotor blades 261, stator blades 222 with respect to rotor blades 261, and blades 231 with respect to rotor blades 271. These blades are controlled-position blades, in particular have angular positions controllable during operation of the steam turbine.

Preferably, as in the embodiment of FIG. 2, there is a row of controlled-position blades just upstream the first expansion stage of the steam turbine, i.e. blades 261 of turbine 200. Blades 261 belong to the first expansion stage of the steam turbine which is also the first expansion stage of the high-pressure section of steam turbine. In the embodiment of FIG. 2, there also is a row of controlled-position blades just upstream the first expansion stage of the low-pressure section of steam turbine, i.e. blades 271 of turbine 200.

In addition to the row of controlled-position blades just upstream the first expansion stage of the steam turbine, advantageously, there may be other rows of controlled-position blades. For example, in the embodiment of FIG. 2, there is a row of controlled-position blades just upstream the second expansion stage of the steam turbine, i.e. blades 262 of turbine 200.

As already anticipated, the embodiment of FIG. 2 comprises two actuation assemblies; however, alternative embodiments may comprise only one actuation assembly or more than two actuation assemblies. Considering FIG. 2, according to some preferred embodiments, only the first actuation assembly is present, i.e. the actuation assembly designed to move the first row of stator blades (221 in FIG. 2) and possibly one or more following rows of stator blades (e.g. 222 in FIG. 2).

Steam turbine 200 includes the inner casing section 220 housing expansion stages (i.e. blades 261, 262, 263) and the outer casing 210 surrounding the inner casing section 220; it is to be noted that the inner casing section 220 is an inner casing. Furthermore, it comprises the actuation assembly 280, i.e. the first actuation assembly (see also FIG. 3), arranged to rotate the stator blades 221 and 222. According to a simpler case, exemplified in FIG. 3, the actuation assembly 280 is arranged to rotate only the stator blades 221.

This actuation assembly comprises an actuation mechanism 281 and a plurality of transmission devices 285 and 286; the transmission devices 285 and 286 are arranged to transmit rotation movements from the actuation mechanism 281 respectively to the stator blades 221 and 222; the actuation mechanism 281 is advantageously positioned between the outer casing 210 and the inner casing 220, more precisely in the interspace between the outer casing 210 and the inner casing 220.

Steam turbine 200 comprises further a command rod 289 for commanding the actuation mechanism 281; also command rod 289 may be considered a component of the first actuation assembly. Advantageously, in this case, the outer casing 210 has a through hole partially housing the command rod 289; in fact, the actuation mechanism (as well as the controlled-position stator blades) may be commanded from outside of the steam turbine and steam leakage is limited to the single-rod hole between the external environment and the interspace environment (at relatively low pressure, i.e. lower than the pressure in the flowpath of the steam turbine); in general, one or more seals are associated with the command rod. Preferably, in this case, command rod 289 is arranged to make movements of translation and/or rotation.

Preferably, command rod 289 comprises one or more articulated joints for compensating the deformations due to the thermal expansions of steam turbine 200 and of the command rod 289, which are stronger closer to the turbine axis “R” of steam turbine 200.

Preferably, the actuation mechanism 281 of the actuation assembly 280 comprises a rotatable ring 310, rotatable about the turbine axis “R” of steam turbine 200 and the command rod 289 is arranged to actuate rotations of rotatable ring 310.

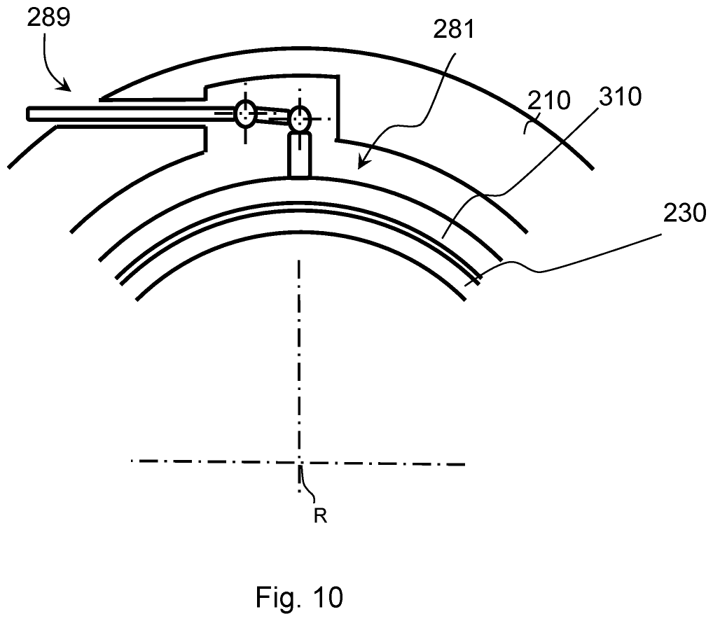

In a first embodiment, illustrated in FIG. 10, the command rod 289 is arranged tangentially with respect to the rotatable ring 310 and is coupled to the rotatable ring 310, in particular with a hinge. In this first embodiment, the command rod 289 is configured to make movements of translation in order to actuate rotations of the rotatable ring 310 around the turbine axis “R”.

In a second embodiment, the command rod 289 is arranged tangentially with respect to the rotatable ring 310 and is coupled to the rotatable ring 310, in particular with a worm gear. In this second embodiment, the command rod 289 is configured to make movements of rotation in order to actuate rotations of the rotatable ring 310 around the turbine axis “R”.

In a third embodiment, the command rod 289 is arranged radially with respect to the rotatable ring 310 and is coupled to the rotatable ring 310, in particular with a 90° gear. In this third embodiment, the command rod 289 is configured to make movements of rotation in order to actuate rotations of the rotatable ring 310 around the turbine axis “R”.

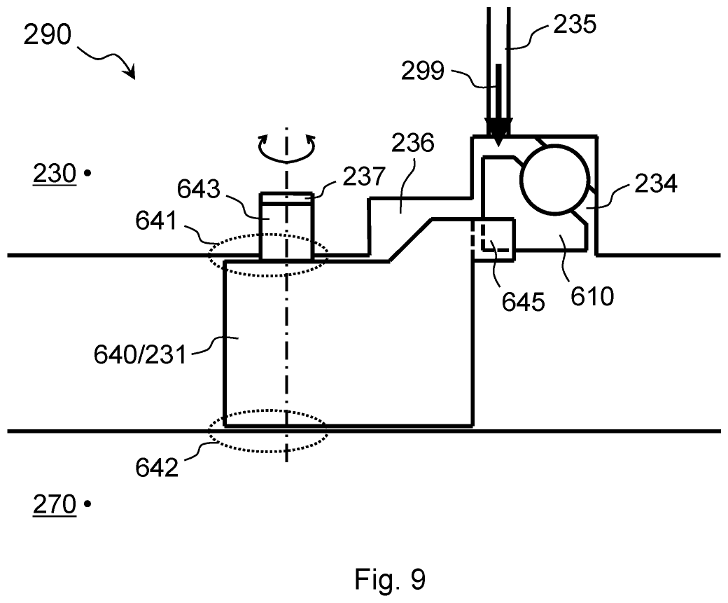

Steam turbine 200 comprises another inner casing section 230 housing expansion stages (i.e. blades 271, 272, 273) and the outer casing 210 surrounding the inner casing section 230; it is to be noted that the inner casing section 230 is an inner casing. Furthermore, it comprises another actuation assembly 290, i.e. the second actuation assembly (see also FIG. 9), arranged to rotate the stator blades 231. According to a more complex case, the actuation assembly 290 might be arranged to rotate other stator blades.

This actuation assembly comprises an actuation mechanism 291 and a plurality of transmission devices 295; the transmission devices 295 are arranged to transmit rotation movements from the actuation mechanism 291 to the stator blades 231, and may be integrated partially into actuation mechanism 291 and partially into stator blades 231; the actuation mechanism 291 is advantageously positioned inside the inner casing 230, more precisely in a recess seat of the inner side of the inner casing 230.

Steam turbine 200 comprises further another command rod 299 for commanding the actuation mechanism 291; also command rod 299 may be considered a component of the second actuation assembly. Advantageously, in this case, the outer casing 210 has a through hole partially housing the command rod 299; in fact, the actuation mechanism (as well as the controlled-position stator blades) may be commanded from outside of the steam turbine and steam leakage is limited to the single-rod hole between the external environment and the interspace environment (at relatively low pressure i.e. lower than the pressure in the flowpath of the steam turbine); in general, one or more seals are associated with the command rod. Preferably, in this case, command rod 299 is arranged to make movements of translation or substantial translation. Preferably, command rod 299 can be arranged according to the embodiments described above with reference to command rod 289.

In case of the actuation assembly 290, the inner casing 230 has advantageously a through hole partially housing the command rod 299; in fact, steam loss is limited to the single-rod hole between the interspace environment and the flow path environment.

A first embodiment of the first actuation assembly 280 will be described in the following with reference to FIG. 3.

The plurality of transmission devices 285 of the actuation assembly 280 comprises a plurality of actuation rods 320 arranged to correspondingly rotate a plurality of stator blades 340 (corresponding to blades 221 in FIG. 2); stator blades 340 may rotate about a respective spanwise direction transversal to the flow direction of the steam, in particular radially oriented. Preferably each actuation rod 320 is rigidly coupled connected to a respective stator blade 340 and extends parallel to its spanwise direction.

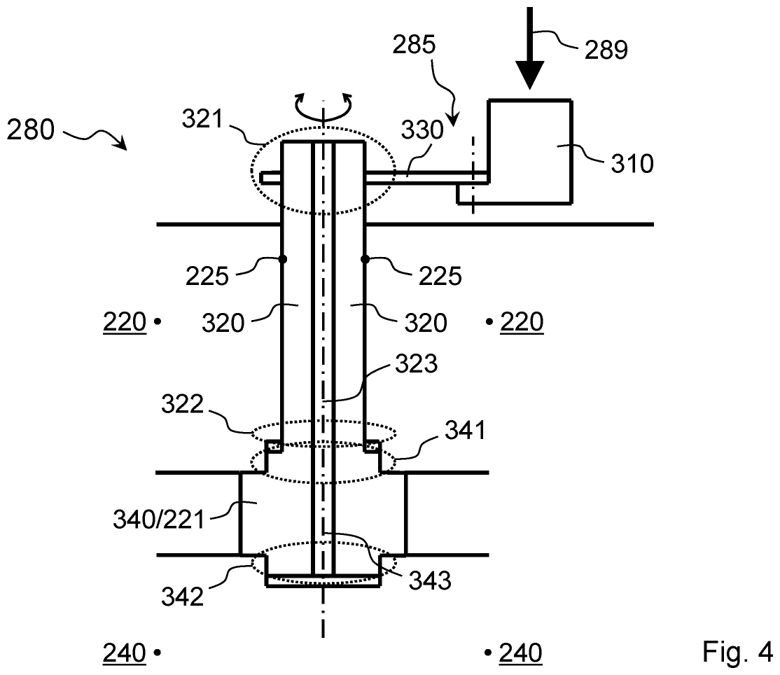

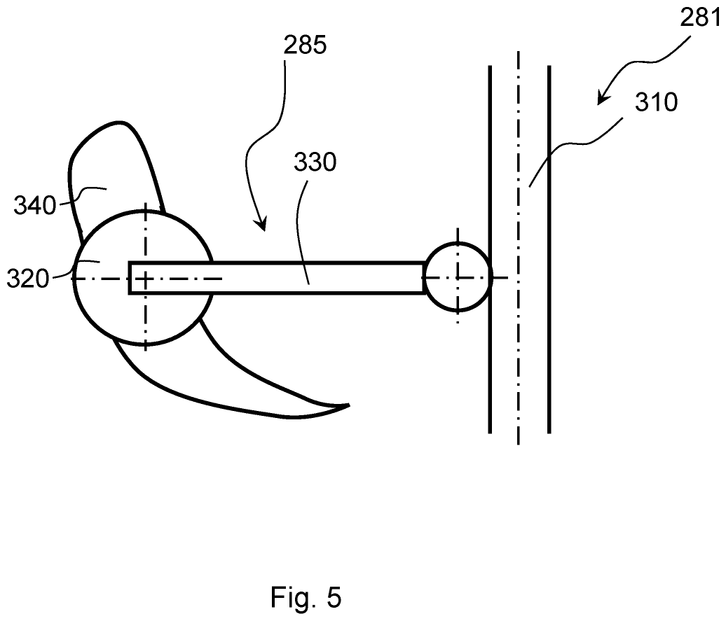

Preferably, the transmission devices 285 comprise are arranged to transmit a rotation movement from ring 310 to each of actuation rods 320. According to the embodiment of FIG. 4 and FIG. 5, such transmission devices 285 comprise a plurality of arms 330 coupled with ring 310 and the plurality of actuation rods 320. It is to be noted that arms 330 may also be considered components of actuation mechanism 281.

In particular, according to the embodiment of FIG. 4 and FIG. 5, each arm 330 extends transversally to the spanwise dimension of the respective stator blade 340 and has a first end rigidly connected to a respective actuation rod 320 and a second end hinged to the actuation mechanism 281, in particular to the ring 310. Preferably, each arm is hinged to the actuation mechanism 281, in particular to ring 310, through a simple cylindrical hinge. This implies a small axial movement of ring 310 during rotation of ring 310.

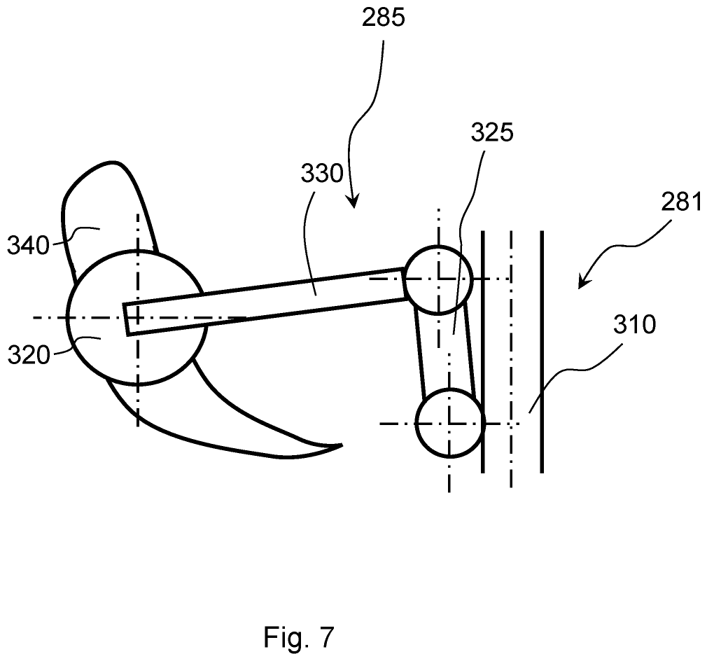

A second embodiment of the first actuation assembly 280 will be described in the following with reference to FIG. 6 and FIG. 7.

The plurality of transmission devices 285 of the actuation assembly 280 according to the second embodiment comprises a plurality of actuation rods 320 arranged in the same way as the actuation rods 320 described in the first embodiment. The transmission devices 285 also comprise a plurality of arms 330. Each arm 330 extends transversally to the spanwise dimension of the respective stator blade 340 and has a first end and a second end, the first end is rigidly connected to a respective actuation rod 320. It is to be noted that arms 330 may also be considered components of actuation mechanism 281.

The plurality of transmission devices 285 of the actuation assembly 280 according to the second embodiment also comprises a plurality of connecting rods 325 having a first end and a second end, the first end of each connecting rod 325 is hinged to the second end of a respective arm 330 and the second end of each connecting rod 325 is hinged to the actuation mechanism 281, in particular to the ring 310. Preferably, each connecting rod 325 is hinged to the respective arm 330 and to the actuation mechanism, in particular to ring 310, by means of spherical joints. Advantageously, this prevents axial movements of ring 310. It is to be noted that connecting rods 325 may also be considered components of actuation mechanism 281.

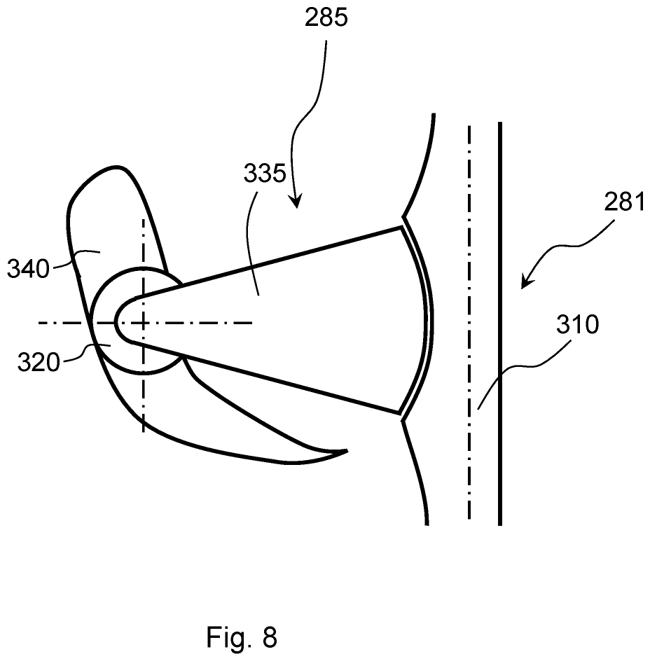

A third embodiment of the first actuation assembly 280 will be described in the following with reference to FIG. 8.

The plurality of transmission devices 285 of the actuation assembly 280 according to the third embodiment comprises a plurality of actuation rods 320 arranged in the same way as the actuation rods 320 described in the first embodiment. The transmission devices 285 also comprise a plurality of transmission members 335. Each transmission member 335 is rigidly connected to a respective actuation rod 320 and has a first arched surface centered on the spanwise direction of the respective stator blade 340. It is to be noted that transmission members 335 may also be considered components of actuation mechanism 281.

The actuation mechanism 281 according to the third embodiment, in particular the ring 310, has a plurality of second arched surfaces. Each second arched surface of the actuation mechanism 281 is complemental to a respective first arched surface of a transmission member and positioned in order to abut against it. Advantageously, each couple of first and second arched surfaces are configured to slide against each other during a rotation of the ring 310 in order to actuate a rotation of actuation rods 320 and the stator blades 340 connected to the actuation rods 320. Advantageously, this prevents axial movements of ring 310.

In the first, second and third embodiments, actuation rod 320 and stator blade 340 form a single piece or are fixedly coupled together and their axes coincide as shown in FIG. 3, FIG. 4, FIG. 5, FIG. 6, FIG. 7 and FIG. 8.

Preferably, inner casing 220 may have a plurality of through holes 225 partially housing the plurality of actuation rods 320. According to the embodiment of FIG. 3, the axis of vane 340, the axis of actuation rod 320, and the axis of hole 225 coincide. In the embodiments of FIG. 4 and FIG. 6, there may be some steam leakage from the holes housing the actuation rods; however, such leakage is internal to the steam turbine and therefore is not truly detrimental to the operation of the machine, and is limited due to the relatively small pressure difference between the interspace and the flowpath; furthermore, one or more seals are associated with the actuation rods.

According to the embodiments of FIG. 4 and FIG. 6, each of actuation rod 320 has an axial through rod hole 323 whereby a first rod end 321 and a second rod end 322 are fluidly connected, each of stator blades 340 has a through vane hole 343 whereby a first vane end 341 and a second vane end 342 end are fluidly connected, and rod hole 323 is fluidly connected with vane hole 343. In this case, there is a relatively low pressure differences between first rod end 321 and second rod end 322 and between first vane end 341 and second vane end 342, so that relatively low pressure forces have to be counteracted by the components of actuation assembly 280.

According to the embodiments of FIG. 4 and FIG. 6, first vane end 341 is hinged to an inner side of inner casing 220; advantageously, second vane end 342 is hinged to a stator member 240 of steam turbine 200 that may be for example an inlet volute of steam turbine 200 or an extension thereof. It is to be noted that, according to alternative embodiments, vane 340 may be hinged only at one end.

In general, the actuation mechanism according to the above described embodiments may be considered an assembly of all components of the actuation assembly apart from the command rod and actuation rods. A typical component of the actuation mechanism is an actuation rotatable ring. In other words, the actuation mechanism is an assembly of components that allows to transfer motion from the command rod to the actuation rods.

An embodiment of the second actuation assembly 290 will be described in the following with reference to FIG. 9.

The actuation mechanism 291 of the actuation assembly 290 comprises a rotatable ring 610, rotatable about the axis of steam turbine 200; preferably, rotatable ring 610 is positioned in an annular seat 234 of inner casing 230; more preferably, annular seat 234 is a recess in an inner side of inner casing 230; in this way, ring 610 does not substantially interfere with the flow of steam. In particular, ring 610 is connected to annular seat 234 through bearings, positioned inside seat 234 in order allow rotations of ring 610.

According to the embodiment of FIG. 9, the transmission devices 295 of the actuation assembly 290 are arranged to transmit a rotation movement from ring 610 to each of stator blades 640 (corresponding to blades 231 in FIG. 2). In this embodiment, stator blades 640 may rotate about an axis transversal to the flow direction of the steam, in particular radially oriented. In this embodiment, the transmission devices 295 are integrated partially into actuation ring 610 and partially into stator blades 640; for example, ring 610 has a plurality of teeth cooperating with a plurality of teeth 645 of stator blades 640. Each stator vane 640 may have only one tooth 645 or, preferably, a plurality of teeth 645. Preferably, the plurality of teeth 645 is positioned outside of the flow path and moves inside a recess 236 in an inner side of inner casing 230.

According to the embodiment of FIG. 9, first vane end 641 is hinged to an inner side of inner casing 230; for this purpose, stator vane 640 has a pivot 643 fit into a blind hole 237. It is to be noted that, according to alternative embodiments, second vane end 642 may be hinged.

According to the embodiment of FIG. 9, inner casing 230 has one through hole 235 ending at recess 234 wherein command rod 299 may slide for commanding rotation of ring 610 (see arrow in FIG. 6).

It is to be noted that the mechanical solutions shown in FIG. 3, FIG. 4, FIG. 5, FIG. 6, FIG. 7, FIG. 8 and FIG. 9 may be used elsewhere in a steam turbine for moving stator blades.

The actuation rotatable ring may be positioned A) between an outer casing of the steam turbine and an inner casing of the steam turbine or B) inside an inner casing of the steam turbine.

The steam turbines just described and other similar embodiments allow to implement methods of regulating steam flow.

Embodiments of these methods comprises the step of:
changing angular positions of at least one row of stator blades during operation of the steam turbine;
   this step corresponds to blocks 720, 730 and 740 in the flow chart of FIG. 7.

The angular positions may be changed once or, more typically, several times during operation of the steam turbine. An external control unit may be in charge of deciding when carry out such change and provide commands to corresponding actuators, for example electric motors.

Preferably, the movable stator blades are those positioned just upstream the first expansion stage of the steam turbine.

Advantageously, one or more other rows of stator blades may be moved, for example a second and/or a third rows of stator blades.

The movable stator blades may be those positioned just upstream the first expansion stage of any expansion section of the steam turbine.

FIG. 7 shows a flow chart of an embodiment of a method of regulating steam flow in a steam turbine. This method has a start step 710 and an end step 790 that may correspond respectively to start-up of the steam turbine and shut-down of the steam turbine.

According to this embodiment, angular position of a stator vane is changed through the steps of:
turning (block 720) a command rod protruding from an outer casing of the steam turbine,
transmitting (block 730) a rotation movement from the command rod to an actuation rotatable ring, the actuation rotatable ring being positioned inside an outer casing of the steam turbine, and
transmitting (block 740) a rotation movement from the actuation rotatable ring to the stator vane.

The above mentioned three steps are repeated for each of the movable stator blades; typically, movements of all movable stator blades occur at the same time. It is to be noted that a rotatable ring may act on one or more rows of movable stator blades.

Although the above mentioned three steps are logically in sequence, the time difference between them may be very short or even null.

Typically, the above mentioned three steps are repeated many times during operation of the steam turbine for all movable stator blades; this is illustrated through the loop L in FIG. 7.

1.-15. (canceled)

16. A steam turbine with a plurality of expansion stages, the steam turbine comprising:
an inner casing housing at least said at least one expansion stage, an outer casing surrounding said inner casing,
a row of stator blades upstream of said at least one expansion stage, the stator blades of the row having angular positions controllable during operation of the steam turbine, and
an actuation assembly arranged to rotate the stator blades of said row, the actuation assembly comprising an actuation mechanism, a plurality of transmission devices and a command rod,
wherein the command rod is arranged to command the actuation mechanism, wherein the transmission devices are arranged to transmit rotation movements from the actuation mechanism to the stator blades of said row,
wherein the actuation mechanism is positioned between the outer casing and the inner casing.

17. The steam turbine of claim 16, wherein said row of stator blades is positioned upstream of all expansion stages of said steam turbine.

18. The steam turbine of claim 16, comprising a rotor arranged to revolve around a turbine axis, wherein said actuation mechanism comprises a ring extending around said turbine axis, said ring being rotatable around said turbine axis.

19. The steam turbine of claim 16,
wherein the plurality of transmission devices comprises a plurality of actuation rods,
wherein each of said stator blades has a spanwise direction, and
wherein each actuation rod is rigidly coupled to a respective stator blade and extends parallel to said spanwise direction.

20. The steam turbine of claim 19, wherein the plurality of transmission devices comprises a plurality of arms, wherein each arm has a first end and a second end, wherein each arm is rigidly coupled to a respective actuation rod at the first end and extends transversally to the spanwise dimension of said actuation rod, wherein each arm is hinged to said actuation mechanism at the second end.

21. The steam turbine of claim 19,
wherein the plurality of transmission devices comprises a plurality of arms, wherein each arm has a first end and a second end, wherein each arm is rigidly coupled to a respective actuation rod at the first end and extends transversally to the spanwise dimension of said actuation rod,
and wherein the plurality of transmission devices comprises a plurality of connecting rods, wherein each connecting rod has a first end and a second end, wherein the first end of each connecting rods is hinged to the second end of a respective arm and the second end of each connecting rods is hinged to the actuation mechanism.

22. The steam turbine of claim 19,
wherein the plurality of transmission devices comprises a plurality of transmission members,
wherein each transmission member is rigidly coupled to a respective actuation rod and has a first arched surface centered on said spanwise direction,
and wherein said actuation mechanism has a plurality of second arched surfaces, each second arched surface being complemental to a respective first arched surface and abutting against said respective first arched surface.

23. The steam turbine of claim 19,
wherein each of the actuation rods of said plurality has an axial rod hole whereby a first rod end and a second rod end are fluidly connected,
wherein each of the stator blades of said row has a vane hole whereby a first vane end and a second vane end are fluidly connected, and wherein said rod hole is fluidly connected with said vane hole.

24. The steam turbine of claim 16, wherein the plurality of transmission devices comprises a plurality of actuation rods and wherein the inner casing has a plurality of holes housing the plurality of actuation rods.

25. The steam turbine of claim 16, wherein the outer casing has a through hole partially housing said command rod, and wherein said command rod comprises preferably one or more articulated joints.

26. A steam turbine with a plurality of expansion stages, the steam turbine comprising:
an inner casing housing at least said at least one expansion stage,
an outer casing surrounding said inner casing,
a row of stator blades upstream of said at least one expansion stage the stator blades of the row having angular positions controllable during operation of the steam turbine, and
an actuation assembly arranged to rotate the stator blades of said row, the actuation assembly comprising an actuation mechanism, a plurality of transmission devices and a command rod,
wherein the command rod is arranged to command the actuation mechanism,
wherein the transmission devices are arranged to transmit rotation movements from the actuation mechanism to the stator blades of said row,
wherein the actuation mechanism is positioned inside the inner casing.

27. The steam turbine of claim 26, wherein each of the stator blades of said row is hinged to the inner casing and has a tooth for being rotated.

28. The steam turbine of claim 26,
wherein the inner casing has a through hole partially housing said command rod, wherein the outer casing has a through hole partially housing said command rod, and
wherein said command rod comprises preferably one or more articulated joints.

29. A method of regulating steam flow in a steam turbine, comprising the step of:
changing angular positions of at least one row of stator blades during operation of the steam turbine; wherein angular position of a stator vane is changed through the steps of:
turning a command rod protruding from an outer casing of the steam turbine,
transmitting a rotation movement from the command rod to an actuation rotatable ring, the actuation rotatable ring being positioned inside an outer casing of the steam turbine, and
transmitting a rotation movement from the actuation rotatable ring to the stator vane.

30. The method of claim 29, wherein the actuation rotatable ring is positioned between an outer casing of the steam turbine and an inner casing of the steam turbine or inside an inner casing of the steam turbine.
